(19) United States
(12) Patent Application Publication
(10) Pub. No.: US 2023/0129888 A1
(43) Pub. Date: Apr. 27, 2023

(54) HYDROGEN INFUSION SYSTEM

(71) Applicant: Welker, Inc., Sugar Land, TX (US)

(72) Inventors: Wade Williams, Sugar Land, TX (US); Stephen Russell Sams, Sherman, TX (US)

(21) Appl. No.: 18/047,516

(22) Filed: Oct. 18, 2022

Related U.S. Application Data
(60) Provisional application No. 63/262,914, filed on Oct. 22, 2021.

(51) Int. Cl. F17D 3/12; G05D 7/06; F17D 5/00

(52) U.S. Cl. CPC F17D 3/12; G05D 7/0652; F17D 5/005

(57) ABSTRACT

A hydrogen infusion system is provided that introduces hydrogen to a natural gas pipeline in order to reduce greenhouse gas emission of the pipeline. The system uses pressure differentials between the hydrogen and the natural gas pipeline to introduce the hydrogen, and as a result the system does not use a pump or any method of compression to enter the pipeline.

### CROSS-REFERENCE TO RELATED APPLICATIONS

The present application claims priority to U.S. Provisional Patent Application Publication No. 63/262,914, filed Oct. 22, 2021, the entire contents of which are incorporated herein by reference.

### FIELD OF INVENTION

The present invention relates generally to natural gas pipelines, and more generally to a system for infusing hydrogen into a natural gas pipeline to reduce greenhouse gas emissions.

### BACKGROUND OF INVENTION

In recent years, the natural gas industry has used hydrogen as a natural gas additive to help reduce greenhouse gas emissions. The process of combining hydrogen into the natural gas present in the pipeline system requires a reliable and steady infusion to reach a target level of one percent to twenty percent (1%-20%) hydrogen infusion.

Methods and systems for pumping or compressing and pushing hydrogen into a pipeline system exist, but those systems require the use of a pump. Including a pump in such a system introduces additional parts, which further increases the likelihood of potential maintenance or even failure.

Further, by introducing hydrogen into natural gas, appliances and burners need to be redesigned to accommodate the burn characteristics of hydrogen (as opposed to the burn characteristics of natural gas). Thus, proper infusion is necessary within a system to be compatible with such appliances and burners.

### SUMMARY OF INVENTION

The present invention overcomes many of the shortcomings and limitations of the prior art. The current invention is a pumpless (or “compressor-less”) system that uses differential pressure to infuse hydrogen into a natural gas pipeline using program driven solenoid valves. The solenoid valves open and close depending on the concentration of hydrogen that is to be introduced into the pipeline. The system makes use of existing pipeline pressure to infuse the hydrogen into the pipeline. The system subject hereof uses a precise and accurate blending process that is consistent and repeatable for use with modified appliances and burners.

These and other aspects and advantages of the present invention will become apparent to those skilled in the art after considering the following detailed description in connection with the accompanying drawings.

### BRIEF DESCRIPTION OF DRAWINGS

FIG. 1 is a schematic of a hydrogen infusion system constructed according to the teachings hereof.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

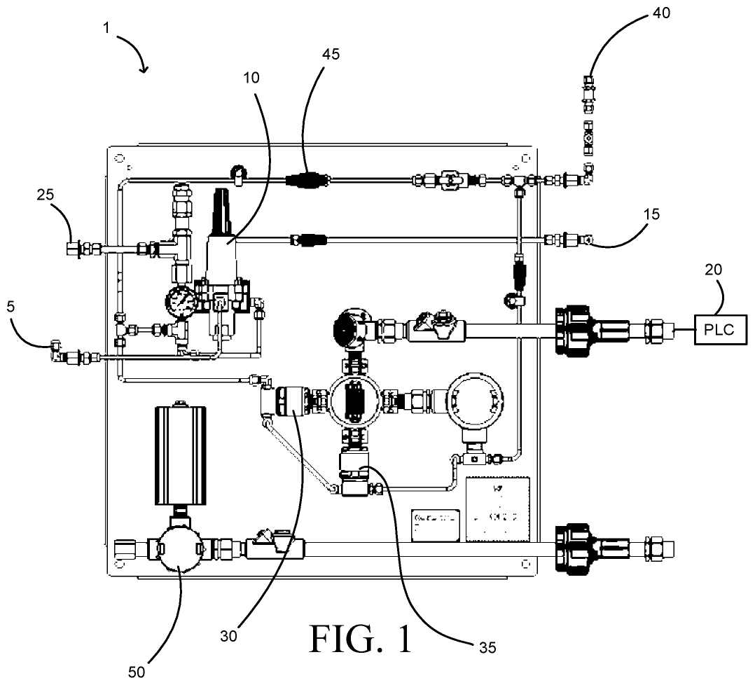

FIG. 1 illustrates a hydrogen infusion system 1 constructed according to the present invention. A hydrogen source (not illustrated) containing hydrogen is preferably provided as a vessel, container, tank, or pipeline near the system 1. The hydrogen source may be in fluid communication with the system 1 via a hydrogen inlet 5. The hydrogen source, when configured to do so, may provide hydrogen to the system 1 by way of the hydrogen inlet 5. The hydrogen in the hydrogen source is preferably stored at a high pressure.

Hydrogen may be initially directed to a regulator 10 that operates to reduce the pressure of the hydrogen supplied via the hydrogen inlet 5. The regulator 10 may be in communication with a pipeline pressure sensor 15 that senses the pressure of the pipeline. The pipeline pressure sensor 15 preferably directly, or indirectly, for example via a programmable logic controller “PLC” 20, instructs the regulator 10 to drop the hydrogen pressure to approximately 20 PSI to 80 PSI above the pipeline pressure sensed by the pipeline pressure sensor 15. Specific geographic locations may require a different differential, and the PLC 20 or manual instruction may account for this difference when required.

By dropping the hydrogen pressure, the hydrogen may be more easily subsequently introduced to the pipeline (not illustrated). However, due to the remaining pressure differential between the hydrogen provided in the system and the pipeline pressure, the system 1 is pumpless. It is based on differential pressure of the source and the target and is thus an infusion system in that it introduces hydrogen into the pipeline.

An exhaust 25 is also preferably provided in communication with the regulator 10 that may relieve excess pressure that is generated when the regulator drops the hydrogen's pressure.

Two solenoids 30, 35 are preferably provided downstream from the regulator 10, though in other embodiments more or fewer solenoids like the solenoids 30, 35 may be provided. The solenoids 30, 35 are preferably in communication with the pipeline (not illustrated) via an outlet 40.

Program logic stored in a memory of the PLC 20 may respond to an incoming flow signal from the natural gas pipeline. Then, based on the percent of hydrogen mix with natural gas that is desired at the specific location, the solenoid 30 and/or the solenoid 35 may open and close for a specific time period. The time period that the solenoids 30 and/or 35 are open may be based on the orifice size of the solenoids 30 and/or 35, the differential pressure that is used, and the flow rate of the natural gas in the pipeline. Solenoids 30, 35 may comprise a high-flow control valve and a low-flow control valve, respectively.

Hydrogen flow into the pipeline may also be measured by a flow meter such as a Coriolis meter that is also providing information to the PLC 20 such that the PLC 20 can make real time adjustments to the flow by varying the degree to which the solenoids 30 and/or 35 are open and for how long. The system 1 is preferably in a constant state of monitoring and adjusting to maintain the desired percentage of hydrogen entering the natural gas pipeline. For example, in one embodiment, the high-flow control valve 30 and the low-flow control valve 35 communicate with the programmable logic controller 20 to allow hydrogen flow from the hydrogen source only when: (a) the high-flow control valve 30 is open; (b) the low-flow control valve 35 is open; or (c) both the high-flow control valve 30 and the low-flow control valve 35 are open. For example, the programmable logic controller 20 is configured to open at least one of the high-flow control valve 30 and the low-flow control valve 35 for a predetermined dwell time proportional to an amount of hydrogen needed to attain the desired hydrogen level in the pipeline.

In at least one embodiment, a downstream gas chromatograph, or “GC” (not illustrated), may also monitor the hydrogen percentage. The GC may also be in communication with the PLC 20 to help adjust the infusion rate. As appreciated by those skilled in the art, other means of measuring hydrogen percentage and providing feedback to the system 1 are also envisioned and foreseeable herein.

While no human interaction is required to adjust the hydrogen infusion rate during operation by the PLC 20, a manual bypass valve 45 may be provided in an alternative embodiment. The bypass valve 45 is preferably downstream of the regulator 10 but upstream of the pipeline. The valve 45 may be manually adjusted to control the amount of pressure-reduced hydrogen to be introduced to the pipeline. The bypass valve 45 may also be in communication with the various meters set forth above so that an operator may finely adjust the valve 45 to provide a desired hydrogen concentration to the pipeline.

Within the system 1, in some embodiments, a heater 50 may also be provided that simply acts to maintain a desired temperature within the system 1. It thus includes necessary components for regulating temperature in the system 1, such as but not limited to a thermostat and electrical components including wiring.

As is evident from the foregoing description, certain aspects of the present invention is not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations and other uses in applications which do not depart from the spirit and scope of the present inventions are deemed to be covered by the inventions which are limited only by the claims which follow.

1. A system for introducing hydrogen into a natural gas pipeline, the system comprising:
a hydrogen source;
a pressure regulator in communication with the hydrogen source to which hydrogen is introduced;
one or more valves that when opened permit flow of hydrogen from the pressure regulator to the natural gas pipeline.

2. The system of claim 1, wherein the one or more valves are controlled by a PLC.

3. The system of claim 2, wherein the PLC is configured to open and close the one or more valves for a predetermined period of time.

4. The system of claim 2, wherein the one or more valves comprise a high-flow control valve and a low-flow control valve.

5. The system of claim 4, wherein the high-flow control valve and the low-flow control valve communicate with the PLC to allow hydrogen flow from the hydrogen source only when:
the high-flow control valve is open;
the low-flow control valve is open; or
both the high-flow control valve and the low-flow control valve are open.

6. The system of claim 2, further comprising a flow meter in communication with the PLC, wherein the PLC is configured to adjust the one or more valves in response to information received from the flow meter.

7. The system of claim 1, further comprising a bypass valve downstream of the pressure regulator.

8. The system of claim 2, further comprising a gas chromatograph in communication with the PLC.

9. The system of claim 1, further comprising an exhaust in communication with the regulator and configured to relieve excess pressure.

10. The system of claim 1, further comprising a pressure sensor.

11. A system for introducing hydrogen into a natural gas pipeline, the system comprising:
a hydrogen source coupled to the natural gas pipeline via conduit piping, wherein hydrogen from the hydrogen source is configured to flow into the natural gas pipeline;
a high-flow control valve and a low-flow control valve coupled to the conduit piping and downstream of the hydrogen tank; and
a programmable logic controller in communication with the high-flow control valve and the low-flow control valve.

12. The system of claim 11, further comprising a pressure regulator in communication with the hydrogen source.

13. The system of claim 12, wherein the pressure regulator comprises a pressure sensor.

14. The system of claim 11, further comprising a flow meter coupled to the conduit piping and configured to monitor hydrogen flow to the pipeline.

15. The system of claim 11, wherein the high-flow control valve and the low-flow control valve communicate with the programmable logic controller to allow hydrogen flow from the hydrogen source only when:
the high-flow control valve is open;
the low-flow control valve is open; or
both the high-flow control valve and the low-flow control valve are open.

16. The system of claim 11, wherein the programmable logic controller is configured to open at least one of the high-flow control valve and the low-flow control valve for a predetermined dwell time proportional to an amount of hydrogen needed to attain the desired hydrogen level in the pipeline.

17. The system of claim 11, further comprising a bypass valve downstream of the pressure regulator.

18. The system of claim 11, further comprising an exhaust in communication with the regulator and configured to relieve excess pressure.

19. The system of claim 11, further comprising a gas chromatograph in communication with the programmable logic controller.

20. The system of claim 11, further comprising a hydrogen inlet coupled to the hydrogen source.
